(19) United States
(12) Patent Application Publication
(10) Pub. No.: US 2014/0125304 A1
(43) Pub. Date: May 8, 2014

(54) SWITCHING REGULATOR

(71) Applicant: DELPHI TECHNOLOGIES, INC., TROY, MI (US)

(72) Inventors: ERIC WIETHEGE, BERGISCH GLADBACH (DE); ANDREAS WOLF, BERGISCH GLADBACH (DE)

(73) Assignee: DELPHI TECHNOLOGIES, INC., TROY, MI (US)

(21) Appl. No.: 14/074,842

(22) Filed: Nov. 8, 2013

(30) Foreign Application Priority Data
Nov. 8, 2012 (EP) 12191868.4

(51) Int. Cl. H02M 3/156

(52) U.S. Cl. CPC H02M 3/1563
USPC 323/282

(57) ABSTRACT

The present invention relates to a switching regulator comprising a detection unit, an output energy store from which an output current can be taken, and a power switch configured to charge the output energy store. The switching regulator is characterized in that the detection unit determines the output current based on the switching signal applied to the power switch.

### CROSS-REFERENCE TO RELATED APPLICATION

This application claims the benefit under 35 U.S.C. §119(a) of European Patent Application EP 12191868.4, filed Nov. 8, 2012, the entire disclosure of which is hereby incorporated herein by reference.

### TECHNICAL FIELD OF INVENTION

This disclosure generally relates to a switching regulator that includes a detection unit configured to estimate an output current of the switching regulator based on a switching signal within the switching regulator.

### BACKGROUND OF INVENTION

Switching regulators are generally known, with switching regulators being used, for example, to generate a constant output voltage from a variable input voltage. If the output voltage is greater than the input voltage, a step-up converter is used. If an output voltage less than the input voltage is required, a step-down converter is used. A shunt is typically used to measure or determine an output current. The shunt is typically a resistor with a relatively small resistance value. A voltage drop is measured across the shunt, and the output current is calculated by the quotient of the voltage drop across the shunt and the resistance value of the shunt. It may be desirable to know the output current if, for example, the switching regulator is being used to charge a battery. However, the dynamic range of such shunt based measurements may have unacceptable accuracy or resolution if the output current is relatively low or close to zero.

### SUMMARY OF THE INVENTION

In accordance with one embodiment, a switching regulator is provided. The switching regulator includes an output energy store from which an output current can be drawn, a shunt, and evaluation circuit, a power switch, and a detection unit. The shunt is configured to provide a voltage drop indicative of the output current. The evaluation circuit is configured to determine the output current based on the voltage drop. The power switch is configured to charge the output energy store based on a switching signal applied the power switch. The detection unit is configured to estimate the output current based on the switching signal. The shunt and the evaluation circuit are used to determine the output current when the output current is not less than a current threshold, and the detection unit is used to determine the output current when the output current is less than a current threshold.

In another embodiment, a method of determining an output current of a switching regulator is provided. The switching regulator includes a shunt and an evaluation circuit that determine the output current based on a voltage drop across the shunt, and a detection unit that estimates the output current based on a switching signal present in the switching regulator. The method includes the step of determining the output current with the shunt and the evaluation circuit if output current is not less than a current threshold. The method also includes the step of determining the output current with the detection unit if output current is less than a current threshold.

In accordance with another embodiment, a switching regulator is provided. The switching regulator includes an output energy store from which an output current can be drawn, a power switch, a detection unit, and signal switch. The power switch is configured to charge the output energy store based on a switching signal applied the power switch. The detection unit is configured to estimate the output current based on the switching signal. The signal switch is configured to couple the switching signal to the detection unit. The signal switch has a configuration that matches the power switch such that a detection signal received by the detection unit has signal timing characteristics that match the charging signal applied to the output energy store by the power switch.

### BRIEF DESCRIPTION OF DRAWINGS

The invention will be described in the following purely by way of example with reference to a possible embodiment and to the enclosed drawings, in which:

FIG. 1 is a circuit diagram of a switching regulator in accordance with an embodiment;

FIG. 2 is graph illustrating a relationship between switching signal and the output current of the switching regulator of FIG. 1 in accordance with an embodiment; and

FIG. 3 is a flow chart illustrating a method of operating the switching regulator of FIG. 1 in accordance with an embodiment.

### DETAILED DESCRIPTION

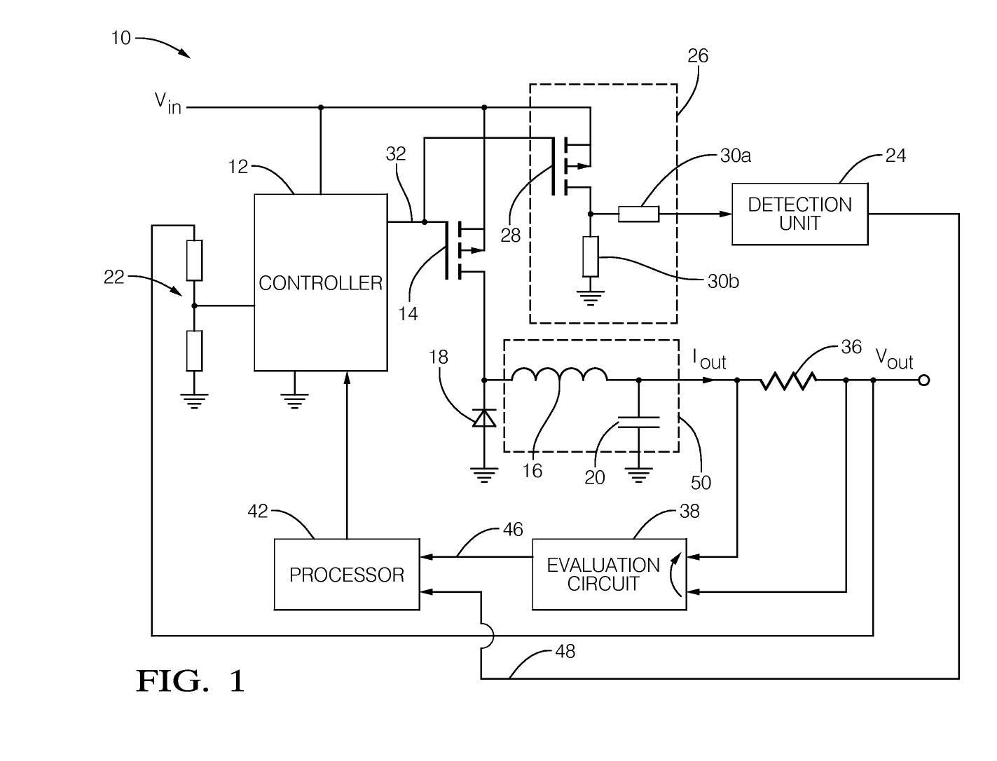

FIG. 1 illustrates a non-limiting example of a switching regulator 10. The switching regulator 10 illustrated is often called a step-down converter. However the teachings presented herein are also applicable to a step-up converter. A controller 12 and a power switch 14 are supplied with an input voltage VIN. The controller 12 is electrically connected to the power switch 14 in a manner effective to operate the power switch 14 from an off-state (OFF) where current does not flow through the power switch 14, and an on-state (ON) where the switch is conductive so current flows through the power switch 14. If the power switch 14 is switched ON by the controller 12, current flows through an inductor 16 connected to the output of the power switch 14 to charge the inductor 16 and a capacitor 20. Current passing through the inductor 16 and/or current drawn from the capacitor 20 provide an output current TOUT being output by the switching regulator 10. The combination of the inductor 16 and the capacitor 20 may be referred to as an output energy store 50. A diode 18 is typically reverse biased (i.e. non-conductive) when the power switch 14 is ON. When the power switch 14 is switched OFF such that the power switch 14 blocks current, the output current TOUT may be provided by energy stored in the inductor 16 and/or the capacitor 20. An output voltage VOUT is supplied to the controller 12 via a voltage divider 22. The switching ON and switching OFF times, or an operating percent duty cycle of the power switch 14 are determined by the controller based on the output voltage VOUT detected by the controller 12, as will be recognized by those in the art.

As used herein, the term controller is used to designate the portion of electronics in the switching regulator 10 that do not have any computational ability such as would be associated with a microprocessor. As such, the controller 12 is limited to hard-wired or ‘dumb’ electronics such as an oscillator, pulse timer, voltage comparator, voltage reference, transistor gate driver, and the like. In contrast, the processor 42 may include electronics with computational ability. It is recognized that the controller 12, the detection unit 24, the processor 42, and the evaluation circuit 38 could all be incorporated into a single device. They are illustrated as separate entities only for the purpose of facilitating the description of the switching regulator 10.

The switching regulator 10 may include a shunt 36 connected to an evaluation circuit 38 for measuring a voltage drop 44 across the shunt 36 indicative of the output current TOUT. The combination of the shunt and the evaluation circuit 38 may have sufficient resolution for measuring an output current TOUT greater than a predetermined current threshold, 100 mA for example. However, if the output current TOUT is less than the current threshold, it may be necessary to provide an additional means of measuring or estimating the output current TOUT.

To this end, the switching regulator 10 includes a detection unit 24 that is generally configured to determine or estimate the output current TOUT based on the switching signal 32. Details of how the detection unit 24 estimates the output current TOUT are provided later in this document. The processor 42 may receive a first current signal 46 from the evaluation circuit 38 and a second current signal 48 from the detection unit 24. The processor 42 may select between the two current signals based on the current values indicated by each of the respective signals. The selection process may include some hysteresis in order to reduce noise in the indication of the output current TOUT. Alternatively, the processor 42 may determine the output current TOUT based on a weighted average of the first current signal 46 and the second current signal 48, where the weighting is determined by how close or far away the output current TOUT seems to be from the current threshold. In general, the shunt 36 and the evaluation circuit 38 are used to determine the output current TOUT when output current TOUT is or seems to be greater than a current threshold (e.g. 100 mA), and the detection unit 24 is used to determine the output current TOUT when the output current is or seems to be less than a current threshold.

The switching regulator 10 may advantageously include a lever convertor 26. In general, the level converter 26 couples the detection unit 24 to the switching signal 32 that operates the power switch 14. In this non-limiting example, the power switch 14 is a metal-oxide-semiconductor-field-effect-transistor (MOSFET). The level converter 26 includes a signal switch 28 that is may also be a MOSFET. Alternatively, bipolar transistors may be used, or other devices suitable for switching electrical power. The devices used for the power switch 14 and the signal switch 28 may be advantageously selected to have similar switching time characteristics, and be arranged in the switching regulator 10 so that the signal received by the detection unit 24 is a close approximation of the signal output by the power switch to the inductor 16. In this example the configuration of the power switch 14 and the signal switch 28 are matched. That is, both are in a common-drain or source-follower configuration. As such, the switching behaviors (ON-to-OFF and OFF-to-ON) are relatively similar so the waveforms or signals at the sources of the MOSFETs are well matched. The lever convertor 26 may also include an electrical network formed by blocks 30A and 30B that may be configured so the load presented to the signal switch 28 mimics the electrical load presented to the power switch 14, thereby further helping to the source signals and optionally to protect the detection unit 24. In other words, the signal switch 28 is configured to couple the switching signal 32 to the detection unit 24, such that a detection signal received by the detection unit 24 has signal timing characteristics like rise-time, fall-time, time-delay, and the like that match the charging signal output by the power switch 14 that is applied to the output energy store 50 by the power switch 14.

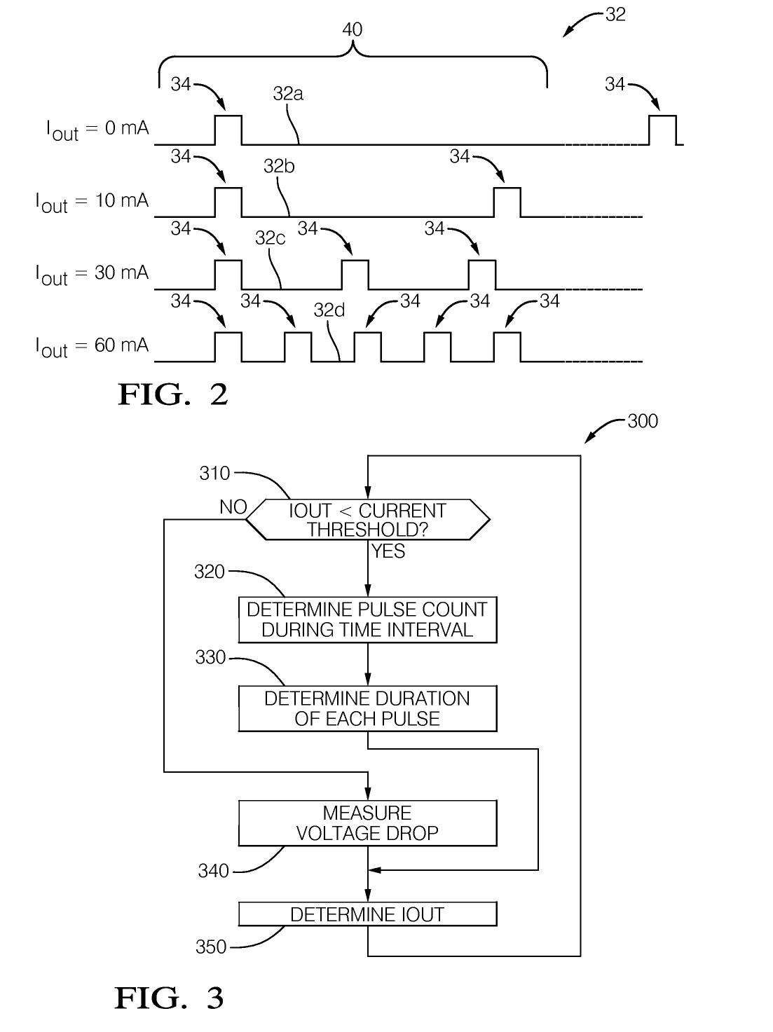

FIG. 2 illustrates multiple non-limiting examples of the switching signal 32 output by the controller 12 to control the power switch 14. By way of example and not limitation, the detection unit 24 may be configured to determine or measure the number, duration, length and/or rate of occurrence of the pulses 34 that make up the switching signal 32 during the time interval 40, and determine an estimate of the output current TOUT based on the content of the switching signal 32. That is, the detection unit 24 outputs a second current signal 48 that corresponds to an estimate of the output current TOUT based on the switching signal 32. The estimate may be made by, for example, a mathematical formula or by empirically determined values which are stored in a look-up table in the detection unit 24.

By way of example and not limitation, a first switching signal 32A may comprise one of the pulses 34 in a time interval 40, and the detection unit 24 may be configured to indicate that the output current TOUT is 0 mA. If two of the pulses 34 are detected as indicated by the second switching signal 32B, the detection unit 24 may be configured to indicate that the output current TOUT is 10 mA. Further exemplary relationships between the rate of occurrence of the pulses 34 and the output current TOUT are represented by the third switching signals 32C and the fourth switching signal 32D in which the occurrence of three and five of the pulses 34 during the time interval 40 correspond to an output current TOUT of 30 mA or 60 mA respectively.

FIG. 3 illustrates a non limiting example of a method 300 of determining an output current TOUT of a switching regulator 10. The switching regulator 10 includes a shunt 36 and an evaluation circuit 38 that determine the output current TOUT based on a voltage drop 44 across the shunt 36. The switching regulator 10 also includes a detection unit 24 that estimates the output current TOUT based on a switching signal 32 present in the switching regulator 10.

Step 310, IOUT<CURRENT THRESHOLD?, may include determining if the output current IOUT is less than a current threshold, for example 100 mA. If YES, the method proceeds to step 320. If NO, the method proceeds to step 340.

Step 320, DETERMINE PULSE COUNT DURING TIME INTERVAL, may include operating the detection unit 24 to count the number of the pulses 34 that occur during the time interval 44.

Step 330, DETERMINE DURATION OF EACH PULSE, may include operating the detection unit 24 to measure, or determine a pulse duration of each of the pulses 34 that occur during the time interval 40. The number (count) of pulses and the duration of each pulse may be used to perform a calculation to estimate the output current TOUT. The choice of what feature(s) of the switching signal 32 is measured generally depends on the kind of signal is output by the controller. If the switching signal is fixed frequency type, the duration of the pulses 32 will change. Alternatively, if the duration of the pulses 32 is fixed, the frequency can be varied by the controller, so the number of pulses during the time interval 40. Alternatively, the information collected in steps 320 and 330 may be used to recall a value from a look-up table that indicates an estimate of TOUT.

Step 340, MEASURE VOLTAGE DROP, may include operating the evaluation circuit 38 to record or measure the voltage drop 44 at the input to the evaluation circuit. The voltage drop 44 may be sampled on a periodic basis so that an average value of the output current TOUT during the time interval 40 can be calculated.

Step 350, DETERMINE TOUT, may include time-averaging or otherwise combining previously received values from either the shunt/evaluation circuit or the detection unit to determine a value of the output current TOUT.

Accordingly, a switching regulator 10 that estimates the output current TOUT based on the content (e.g. number and or duration of the pulses 34) that occur during the time interval 40 is provided. The measurement of the output current TOUT in accordance with the invention can advantageously be used in any desired types of switching regulators, that is, for example, in step-up converters and in step-down converters. The detection unit 24 may estimate the output current IOUT based on the number and/or duration the pulses 34 output by the power switch 14 during the time interval 40. This way of estimating the output current TOUT is in particular advantageous when a switching regulator is used in which the power switch always charges the output energy store for the same length of time per switching signal. The duration of the charge of the output energy store can thus be determined from the knowledge of the number of switching signal. The output current can in turn be determined from the duration of the charging.

In accordance with a further advantageous embodiment, the detection unit 24 may be configured to determine the switching period of the power switch 14 in a specific time interval (duty cycle). The detection unit 24 therefore determines the time interval during which the output energy store 50 is charged by the power switch 14. The detection unit 24 may, for example, determine a percentage of the time interval that is the charge time of the output energy store. The switching period or the pulse width of a switching signal 32 may be measured based on a use of a switching regulator operated at a constant switching frequency. For a switching regulator that operates with a variable switching frequency, the number of the pulses 34 is determined since the switching frequency drops with a smaller output current.

In accordance with a further advantageous embodiment, the detection unit 24 may include a microprocessor (not shown). The microprocessor may be configured to detect the signal at an input to the detection unit 24 with an interrupt advantageously being triggered in the microprocessor by the signal. A particularly simple and fast detection of the switching signal is possible by the use of interrupts.

In accordance with a further advantageous embodiment, the detection unit 24 may be electrically connected directly to the input (e.g. gate) of the power switch 14. If a transistor is used as the power switch 14, the detection unit 24 may directly tap the gate signal to the transistor to receive switching signal. Alternatively, it is likewise possible to detect a voltage at the output of the power switch, that is, for example, at the source terminal or drain terminal of a power switch formed by a field effect transistor (FET).

In accordance with a further advantageous embodiment, the detection unit may be connected to the input of the power switch by means of a level converter 26. In this respect, different signal levels between the power switch and the detection unit can be balanced by the level converter. It is furthermore possible, for example by the interposition of a field effect transistor, to suppress a strong influencing of the switching relationship of the power switch, and in particular of the switching speed of the power switch. Alternatively, a bipolar transistor can also be interposed in dependence on the design of the switching regulator and its operating frequency.

In accordance with a further advantageous embodiment, the switching regulator comprises a shunt and an evaluation circuit by which the output current can be determined from a voltage drop across the shunt.

The range in which the output current of the switching regulator can be determined can be expanded by the additional arrangement of the shunt and of the evaluation circuit. The shunt and the evaluation circuit are advantageously used for the detection of higher output currents, whereas the detection unit determines smaller output currents on the basis of the switching signal of the power switch. The detection unit and the evaluation unit complement one another in this manner.

The invention furthermore comprises a method of determining an output current of a switching regulator comprising a detection unit, an output energy store from which an output current can be taken and an power switch which is configured to charge the output energy store, with switching signal of the power switch being detected and the output current being determined on the basis of the detected switching signal of the power switch.

In accordance with a further advantageous embodiment, the number of switching signal of the power switch is determined in a specific time interval.

In accordance with a further advantageous embodiment, the switching period of the power switch is determined in a specific time interval (duty cycle).

In accordance with a further advantageous embodiment, a switching regulator is used which charges the output energy store by switching signal of a constant duration.

While this invention has been described in terms of the preferred embodiments thereof, it is not intended to be so limited, but rather only to the extent set forth in the claims that follow.

We claim:

1. A switching regulator comprising:
an output energy store from which an output current can be drawn; and
a shunt configured to provide a voltage drop indicative of the output current;
an evaluation circuit configured to determine the output current based on the voltage drop;
a power switch configured to charge the output energy store based on a switching signal applied the power switch; and
a detection unit configured to estimate the output current based on the switching signal, wherein
the shunt and the evaluation circuit are used to determine the output current when the output current is not less than a current threshold; and
the detection unit is used to determine the output current when the output current is less than a current threshold.

2. The switching regulator in accordance with claim 1, wherein the detection unit determines a count of pulses present in the switching signal during a time interval.

3. The switching regulator in accordance with claim 1, wherein the detection unit determines a pulse duration of the pulses during a time interval.

4. The switching regulator in accordance with claim 1, wherein the detection unit is coupled to an input of the power switch by a level converter.

5. A method of determining an output current of a switching regulator comprising a shunt and an evaluation circuit that determine the output current based on a voltage drop across the shunt, and a detection unit that estimates the output current based on a switching signal present in the switching regulator, said method comprising:
determining the output current with the shunt and the evaluation circuit if output current is not less than a current threshold; and
determining the output current with the detection unit if output current is less than a current threshold.

6. The method in accordance with claim 5, wherein the method includes
determining a count of pulses present in the switching signal during a time interval.

7. The method in accordance with claim 5, wherein the method includes
determining a pulse duration of the pulses during a time interval.

8. A switching regulator comprising:
an output energy store from which an output current can be drawn; and
a power switch configured to charge the output energy store based on a switching signal applied the power switch; and
a detection unit configured to estimate the output current based on the switching signal, and
a signal switch configured to couple the switching signal to the detection unit, wherein the signal switch has a configuration that matches the power switch such that a detection signal received by the detection unit has signal timing characteristics that match the charging signal applied to the output energy store by the power switch.
